(19) United States
(12) Patent Application Publication
(10) Pub. No.: US 2016/0072733 A1
(43) Pub. Date: Mar. 10, 2016

(54) USING A NETWORK SWITCH TO CONTROL A VIRTUAL LOCAL NETWORK IDENTITY ASSOCIATION

(71) Applicant: HEWLETT-PACKARD DEVELOPMENT COMPANY, L.P., Houston, TX (US)

(72) Inventors: Christopher Murray, Houston, TX (US); Alex Olson, Houston, TX (US); Christoph L. Schmitz, Houston, TX (US); Osaid Ahmed Shamsi, Houston, TX (US)

(21) Appl. No.: 14/778,405

(22) PCT Filed: Mar. 21, 2013
(86) PCT No.: PCT/US13/33292

§ 371 Date: Sep. 18, 2015

(51) Int. Cl. H04L 12/931

(52) U.S. Cl. CPC H04L 49/354; H04L 49/351

(57) ABSTRACT

A technique includes providing a communication path in a network switch for communication of data between a first device coupled to the switch and a second device coupled to the network switch. The technique includes using the network switch to regulate tagging of the data to control a virtual local area network identity association of the data based at least in part on a network over which the communication occurs.

### BACKGROUND

Computers, such servers, laptops, clients, ultrabooks, and the like, may communicate using a computer network. A traditional type of computer network is a local area network (LAN), in which computers in a particular local area (an office building, a home, a school, and so forth) are coupled together by network cabling. A LAN typically is categorized by a relatively small geographical area, and the LAN defines a domain to contain the broadcasts by its network devices. In this manner, broadcasts that occur over the LAN, in general, do not propagate outside of the LAN, and thus, these broadcasts are not seen by other computer devices, which may be coupled to the LAN through a router, for example.

A virtual LAN (VLAN) overcomes the physical limitations that are imposed by a conventional LAN, in that the broadcast domain for a VLAN may be regulated using software. The VLAN allows devices that are disposed at different physical locations the ability to communicate over the same broadcast domain.

### BRIEF DESCRIPTION OF THE DRAWINGS

FIGS. 1 and 2 are illustrations of systems according to example implementations.

FIGS. 3 and 4 are schematic diagrams of the computer system of FIG. 2 illustrating communication flows among network devices of the computer system according to example implementations.

FIG. 5 is a flow diagram depicting a technique to use a network switch to control virtual local area network (VLAN) identity association according to an example implementation.

FIG. 6 is a block diagram of a computer system illustrating the use of a network switch to control VLAN identity association according to an exemplary implementation.

### DETAILED DESCRIPTION

Techniques and systems are disclosed herein, which employ the use of a network switch to control a virtual local area network (VLAN) identity association for purposes of allowing a given network device that is coupled to the switch the capability to communicate on both public and private networks. More specifically, as disclosed herein, in accordance with example implementations, the network switch may provide this capability for a network device that is “VLAN unaware,” which means that the network device is not aware of the VLAN identity association that is being used in network communications with the network device.

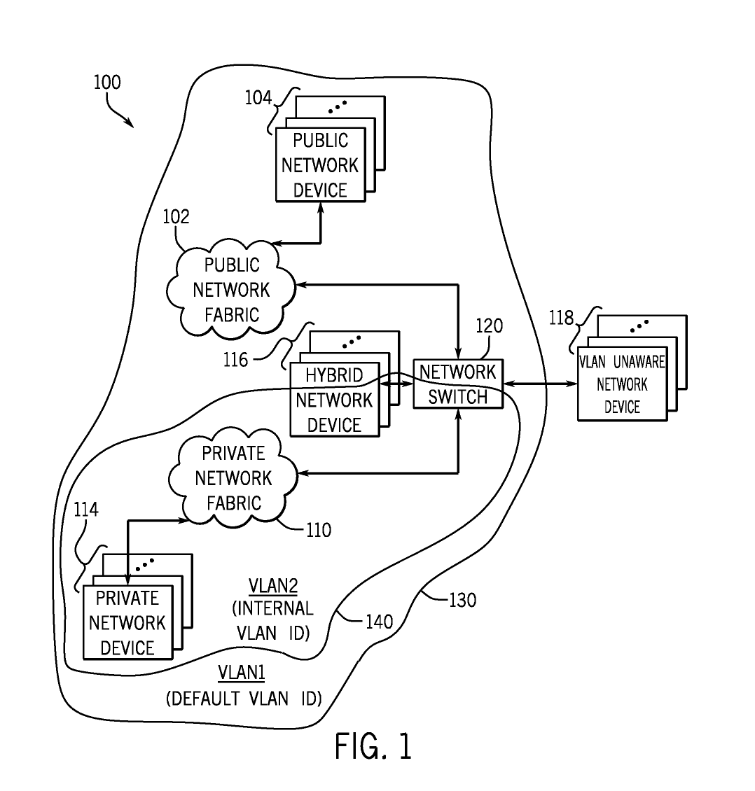

More specifically, FIG. 1 illustrates an example networked computer system 100, which includes public network fabric 102 that accommodates network communications over public Internal Protocol (IP) addresses and private network fabric 110, which accommodates network communications over private IP addresses. In this regard, the public network fabric 102 may include Internet servers, switches, routers, gateways, and the like for purposes of establishing communication with various public network devices 104 coupled to the public network fabric 102, such as servers, clients, laptops, tablets, ultrabooks, desktop computers, smartphones, and so forth.

The private network fabric 110 may also include routers, switches, servers, gateways, and so forth, for purposes of establishing communication with private network devices 114 (computers, servers, clients, and so forth of a particular business enterprise, for example) of a private network. The private network devices 114 may communicate with each other over a private network, as well as communicate with the public network devices 104. This private network may further include network devices 116 that may communicate with the private 114 and public 104 network devices.

For the example of FIG. 1, the network devices 116 are coupled to a network switch 120, which, in general, controls communications between the network devices 116 and the public and private networks.

FIG. 1 also illustrates additional network devices 118 that are coupled to the network switch 120. Each network device 118, for this example, may also communicate over the public and private networks via the network switch 120.

For purposes of defining broadcast domains and regulating these broadcast domains, communications with the above-described network devices occur over one or multiple VLAN domains. For the example of FIG. 1, these VLAN domains include a first VLAN domain 130, which is employed for communications with the public network devices 104 over the public network. In this manner, as illustrated in FIG. 1, the VLAN domain 130 encompasses both the public and private networks so that broadcasts occurring within the VLAN domain 130 are visible to both network devices on the public and private networks. The network devices 116 may belong to the VLAN domain 130 for public network communications; and the network devices 116 are further capable of belonging to a second VLAN domain 140, in which broadcasts are limited to the private network. Thus, for example, for communications between the network devices 116 and other network devices over the private network, the broadcasts are limited to the VLAN domain 140.

The network device 116 is labeled as “hybrid network device” in FIG. 1 due to its ability to control its VLAN identity association, depending on whether device 116 communicates over the public network or private network. As a specific example, a given hybrid network device 116 may tag its data packet (insert the appropriate tag into a packet header, for example), which identifies the packet as belonging either to the first VLAN domain 130 or the second VLAN domain 140. Therefore, for example, for communication between a given hybrid network device 116 and a public network device 104 over the public network that involves the transmission of a packet by the device 116, the device 116 may insert a Customer Virtual Identification (CVID) tag into the packet, which associates the packet as belonging to the first VLAN domain 130. As another example, when communicating with a network device 114 over the private network, a given hybrid network device 116 may insert the appropriate CVID tag into a given data packet to associate the packet as belonging to the second VLAN domain 140.

Unlike the hybrid network device 116, the network device 118 is “VLAN unaware,” (as labeled in FIG. 1) which means that the network device 118 does not tag its transmitted data packet with the appropriate CVIDs to associate the packets with the appropriate VLAN domains. However, in accordance with example implementations disclosed herein, the network switch 120 performs this function for the VLAN unaware network 118.

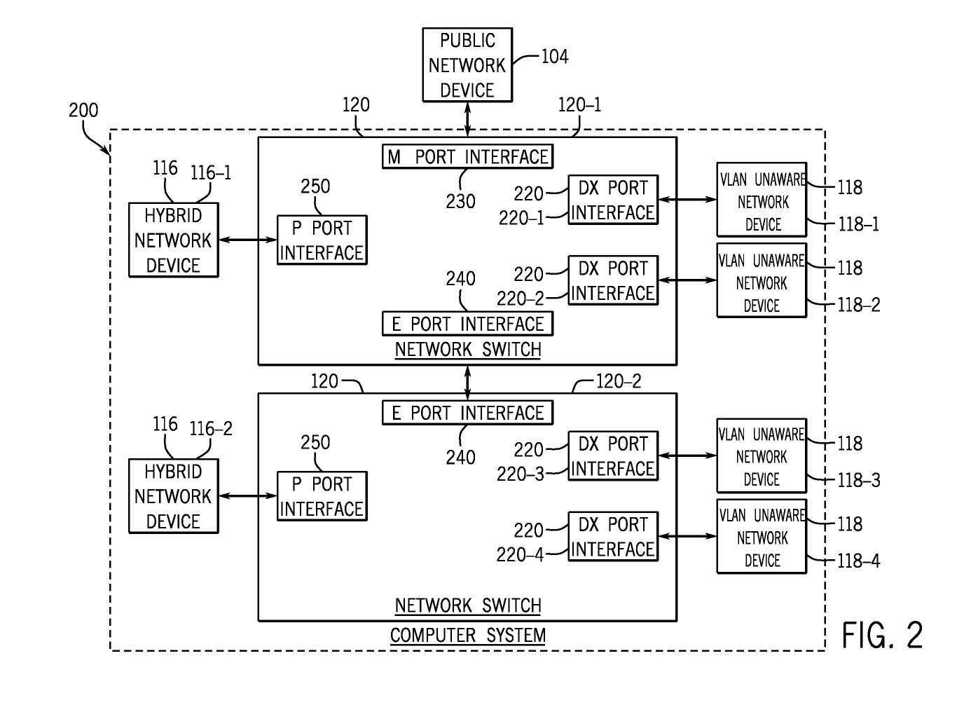

More specifically, referring to FIG. 2, in accordance with an example implementation, an example computer system 200 includes one or multiple network switches 120 (network switches 120-1 and 120-2, being depicted as examples in FIG. 2), which are coupled to various network devices, such as network devices 104, 116-1, 116-2, 118-1, 118-2, 118-3 and 118-4. For purposes of identifying similar components to the computer system of FIG. 1, FIG. 2 uses the same corresponding reference numerals. As a specific example, the network switch 120-1 is a main network switch, which is configured to communicate with public devices, such as the public network device 104 (one switch 104 being depicted in FIG. 2). The one or multiple remaining network switches 120 of the computer system 200, such as network switch 120-2, is configured to communicate with hybrid 116 and VLAN unaware network devices 118 and communicate through an electronic interface with the main network switch 120-1 for purposes of communicating with public network devices 104. As examples, the network switches 120 may each be associated with a particular enclosure (an enclosure for a given server); and the enclosures may be mounted on a rack. However, it is noted that this configuration is merely an example, as other implementations are contemplated, which are within the scope of the appended claims.

As a more specific example, in accordance with an example implementation, the computer system 200 may be used to control and monitor a server (not shown). In this manner, the VLAN unaware network device 118 may be an embedded input/output (I/O) device, which permits control of the server. In this regard, by communicating with the VLAN unaware network device 118, a server may be reset, powered up, remotely controlled, and so forth. The hybrid network device 116 for this example implementation may be a part of a management processor, which allows the management of the server for purposes of reviewing hardware configurations, status datas, performance metrics, system thresholds, software version control information, and so forth.

In general, the network switch 120 includes a device (DX) port interface 220 (DX port interfaces 220-1 and 220-2 for the main network switch 120-1 and DX port interfaces 220-3 and 220-4 for the network switch 120-2 being depicted in FIG. 2 as examples), which communicate over corresponding ports with the VLAN unaware network devices 118. As disclosed herein, the DX port interface 220 selectively adds and removes tags to and from data packets communicated to and from the VLAN unaware network devices 118 for purposes of regulating the VLAN identity association for communications involving the network devices 118. The network switch 120 further includes an electronic (E) port interface 240 for purposes of communicating with the E port interface 240 of another network switch 120; a public (M) port interface 230 for purposes of communicating with the public network devices 104; and a hybrid (P) port interface 250 for purposes of communicating with the hybrid network devices 116 that are capable of controlling their VLAN identity associations.

In general, the VLAN unaware network devices 118 communicate with the hybrid network devices 116 over the private network, and as a result, data involved in this communication does not exit the M port interface 230 of the network switch 120. For purposes of achieving this control, the DX port interface 220 controls the adding and removal of tags for purposes of regulating the VLAN identity association.

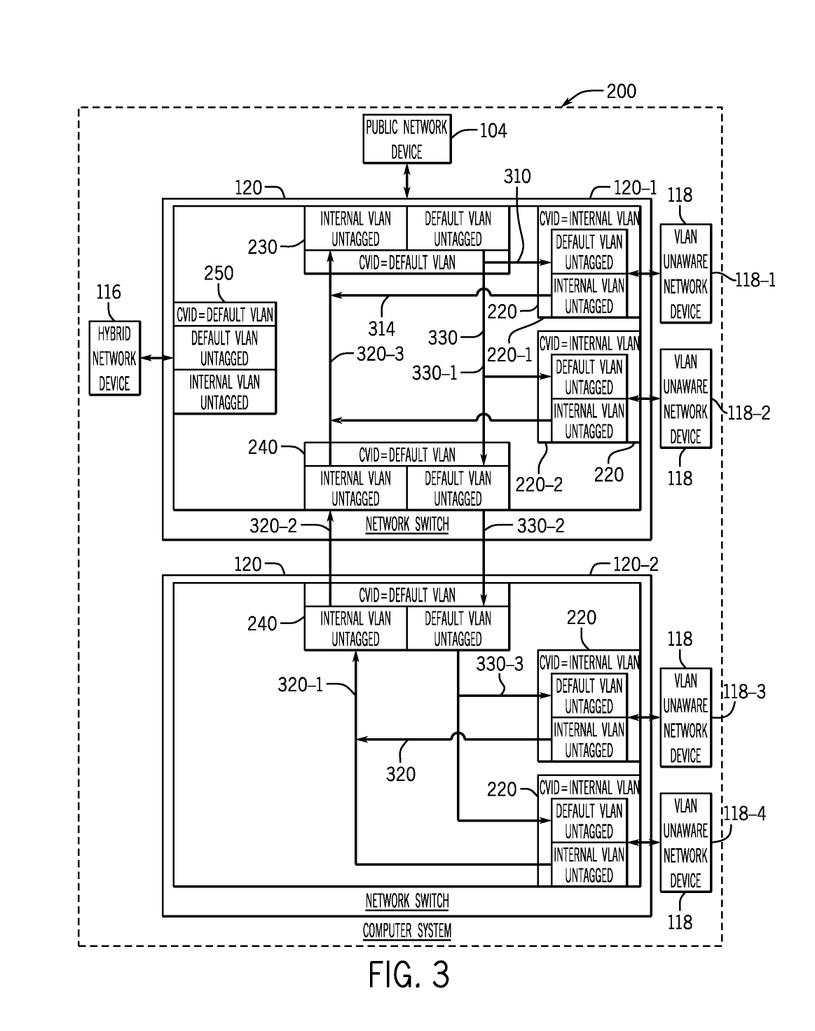

In this regard, FIG. 3 depicts example communication flow paths between the public network device 104 and the network devices 118. The VLAN unaware network devices 118 are assumed to be incapable of sending or receiving VLAN tagged packets. In accordance with example implementations, the DX port 120 tags all packets transmitted from a given VLAN unaware network device 118 with a CVID tag, which associates the packet with the most restrictive VLAN domain, or the VLAN domain 140 (see FIG. 1). This is also called the “internal VLAN ID” herein. If a particular ingress packet from the VLAN unaware network device 118 is intended for a public network device 104, then this communication occurs through the M port 230, and the M port 230 removes the internal VLAN tag from the packet on egress from the network switch 120. Thus, as shown in FIG. 3, for an example outflow communication 314 from the network device 118-1, the DX port interface 220-1 tags the ingress packet with CVID=internal VLADID; and M port 230 untags the packet before communicating the untagged packet to the network device 104.

For an ingress packet arriving from a public network device 104, which is intended for a particular VLAN unaware network device 118, the packet is designated by the M port 230 as being part of the VLAN domain 130 (see FIG. 1), otherwise called the “default VLAN ID” herein. It is noted that in accordance with example implementations, without a CVID tag, the network switch 120 may deem the packet as being part of the default VLAN. Thus, in accordance with example implementations, when an ingress packet arrives from the external network with a destination for a VLAN unaware network device 118, the M port 230 does not tag the packet as a member of the internal VLAN, but rather, allows the packet to remain a member of the default VLAN (CVID explicitly or implicitly=default VLAN ID). Therefore, as illustrated in FIG. 3, an example communication flow 310 involves the M port 230 allowing an ingress packet to remain untagged, which is communicated to the DX port 120-1, which also allows the packet to remain untagged and be communicated to the VLAN unaware network device 118-1.

FIG. 3 also illustrates an egress communication from the network device 118-3 of the network switch 120-2 through a communication path 320 that includes a segment 320-1 through the E port 240 of the network switch 120-2, through a communication segment 320-2 through the E port 240 of the network switch 120-1 and on to the public network device 104 through the M port 230 of the network switch 120-1. Moreover, FIG. 3 illustrates an incoming communication from the public network device 104 along a communication path 330 to the network device 118-4. This flow 330 includes a segment 330-1 into the E port interface 240 of the network switch 120-1, through a communication segment 330-2 through the E port 240 of the network switch 120-2 and then through a segment 330-3 through the DX port 220 of the network switch 120-2.

Thus, the M port interface 230 is a member of both the default VLAN 130 (see also FIG. 1) and the internal VLAN 140 and as such, may receive packets inside the network switch 120 from network devices associated with both VLANs. The M port interface 2302 receives traffic from the network devices 118 on the internal VLAN 140 and receives traffic from the hybrid network device 250 on the default VLAN 130. In accordance with example implementations, the hybrid network device 250 never sends data on the internal VLAN 140 out of the M port interface 230, as the traffic is locked by a switch rule. The DX port 220 is also a member of the default VLAN 130 and the internal VLAN 140, as the DX port 220 receives a packet from the M port interface 230 on the default VLAN and sends the packet untagged to the network device 118. The VLAN unaware network device 118 is configured as an untagged member of the internal VLAN 140. This signifies that any packet at ingress to the network switch 120 from a VLAN unaware network device 118 is tagged with the internal VLAN ID. Packets that egress the M port interface 230 through the internal VLAN have their tags removed. It is noted that the public network device 104 is unaware that VLAN tagging has occurred.

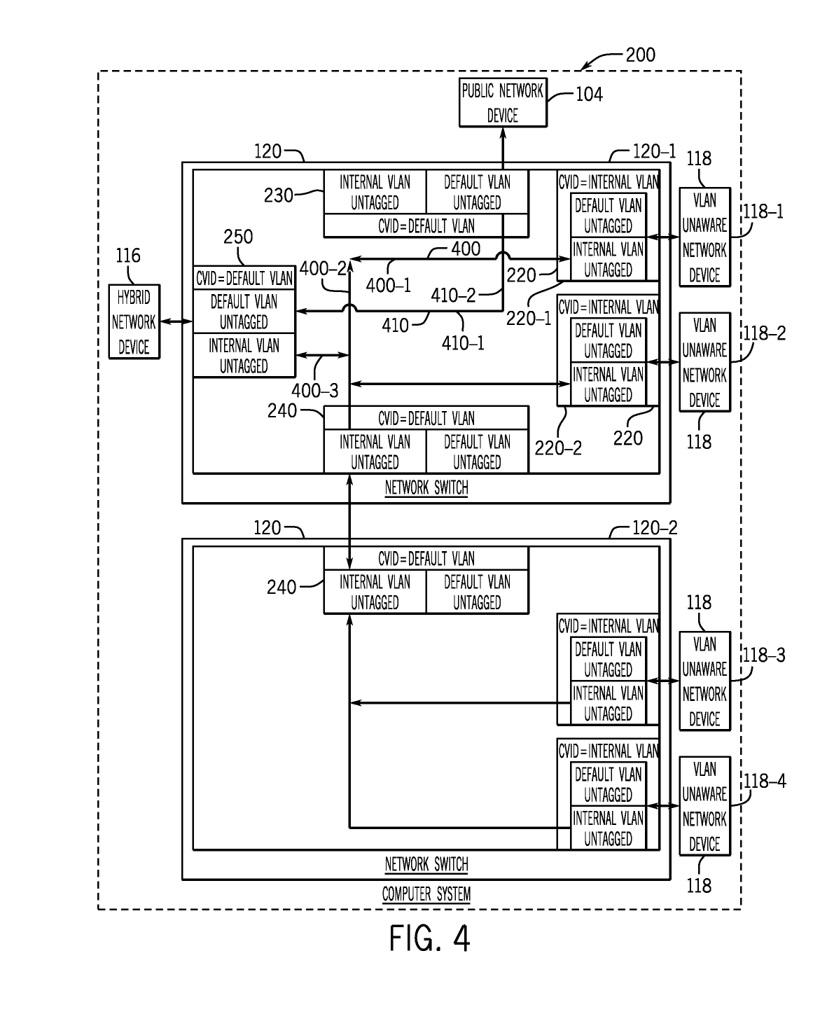

FIG. 4 illustrates example communications with the hybrid network device 116. In general, the hybrid network device 116 communicates with the VLAN unaware network devices 118 on the private network and communicates with the public network devices 104 on the public network. The hybrid network device 116 in accordance with example implementations, contain a single network interface (an Ethernet interface, for example), which provides command and control to the network device 116. In accordance with further example implementations, the hybrid network device 116 may have two virtual Ethernet interfaces: the first virtual Ethernet interface may be used to communicate on the public network using the default VLAN ID, and the second virtual Ethernet interface may be used to communicate with the VLAN unaware network devices 118 using the internal VLAN ID. The P port 250 transmits/receives all packets to/from any VLAN unaware network device 118 in any enclosure as a tagged internal VLAN packet, in accordance with example implementations. The hybrid network device 116 communicates with any public network device 104 through the M port 230 using the default VLAN ID, in accordance with example implementations.

As illustrated in FIG. 4, an example communication between the network devices 116 and 118 involves a communication path 400 (having segments 400-1, 400-2 and 400-3) in which the internal VLAN ID is used. For a communication between the public network device 104 and the hybrid network device 116, a communication flow 410 involves the M port 230 leaving the packet untagged, thereby designating the default VLAN. The packet remains untagged as it is communicated through the P port 250 to the network device 116 (via segments 410-1 and 410-2).

To summarize the tagging and the use of the VLAN IDs, untagged traffic received by the network switch 120 at its M port 230, E port 240 and P port 250 remain untagged and thus, are placed, in accordance with example implementations, in the default VLAN 130. For communications between the M port 230 and a DX port 220, any untagged traffic at ingress at the M port 230 is placed in the default VLAN 130. The M port is a member of the default VLAN 130 and the internal VLAN 140. The network switch 120 places all received untagged traffic in the default VLAN 130. For internal VLAN communications, the internal VLAN 140 is used for private network traffic between the DX ports 220 and each of the P 250, E 240 and M 230 ports. For communications from the DX port 220 to the M 230, E 240 and P 250 ports, all DX ports 220 send traffic to the M port interface 230 on the internal VLAN 140. The DX port interfaces 220 place all received untagged traffic from the network devices 118 on the internal VLAN. These tags are removed at egress by the M port interface 230. The tag is not removed by the P port 250 or E port 240 interfaces.

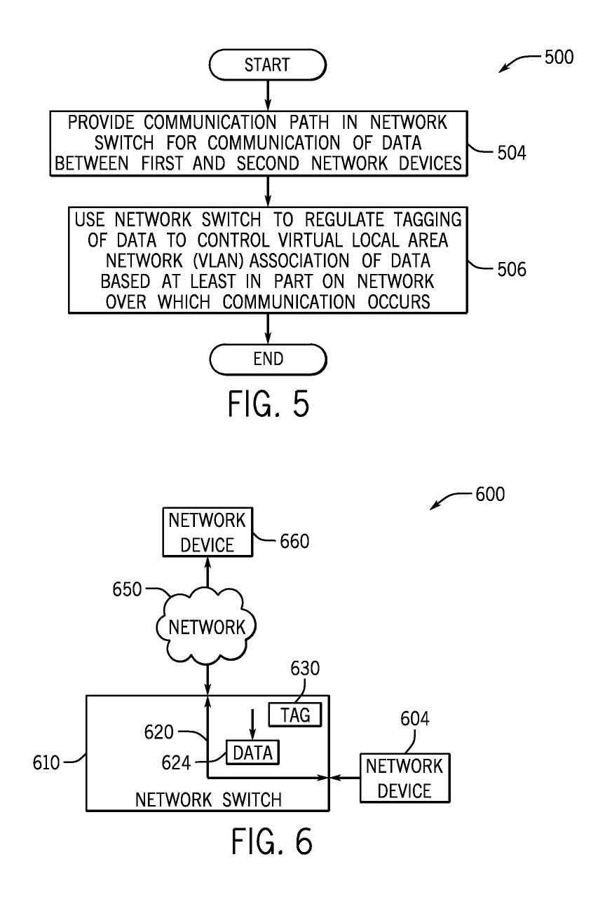

Thus, referring to FIG. 5, in accordance with an example implementation, a technique 500 includes providing (block 504) a communication path in a network switch for communication of data between first and second devices. The network switch is used, pursuant to block 506, to regulate tagging of data to control virtual local area network (VLAN) identity association of data based at least in part on a network over which the communication occurs.

Referring to FIG. 6, in an illustration 600, a network switch 610 may selectively introduce tag(s) 630 to data 624 that is communicated between a VLAN unaware network device 604 and another network device 660 over given network/network fabric 650, which may be, for example, a public or private network/network fabric.

Among the potential advantages of the systems and techniques that are disclosed herein, multiple VLAN unaware devices may communicate with public IP network devices that are VLAN unaware and also communicate on a private IP network with a device that is VLAN tagged. Therefore, the VLAN unaware device may access the public and private devices directly, as a bridging function is not used for the device to communicate with the public IP device. The systems and techniques that are disclosed herein allow a single Ethernet port to be used by a VLAN aware device (instead of two Ethernet ports, for example) for purposes of communicating with public and private IP network devices, which may save costs. Moreover, devices in a management network may not support multiple IP addresses on a single network interface. Other and different advantages are contemplated, which are within the scope of the appended claims.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
providing a communication path in a network switch for communication of data between a first device coupled to the network switch and a second device coupled to the network switch; and
using the network switch to regulate tagging of the data to control a virtual local area network identity association of the data based at least in part on a network over which the communication occurs.

2. The method of claim 1, wherein using the network switch to regulate the tagging of the data comprises:
determining whether the communication occurs over a public network or a private network; and
selectively tagging the data based at least in part on the determination.

3. The method of claim 1, wherein:
the first network device is unaware of the virtual local area network identity association;
the data comprises at least one data packet received from the first network device; and
using the network switch to regulate the tagging of the data comprises inserting a tag in the data packet to indicate membership of the packet to a first virtual local area network of a plurality of virtual local area networks.

4. The method of claim 3, wherein the first virtual local area network is associated with a private network and a second virtual local area network of the plurality of virtual local area networks is associated with a public network.

5. The method of claim 4, the method further comprising:
removing the tag from the data packet; and
communicating the data packet with the removed tag from the network switch to the second network device over the public network.

6. The method of claim 1, wherein the first network device is unaware of the virtual local area network identity association and the data comprises at least one data packet received from the second network device using communication over a public network, the method further comprising:
using the network switch to associate the packet with a virtual local area network associated with the public network.

7. The method of claim 1, wherein:
the first network device is unaware of the virtual local area network identity association;
the second network device is adapted to regulate tagging of data furnished by the second network device to control a local area network identity association of the data furnished by the second network device.

8. A network switch, comprising:
a first port interface coupled to a public network; and
a second port interface coupled to a first network device adapted to communicate data with a second network device coupled to the switch using one the public network or a private network, the second port interface adapted to regulate tagging of the data to control a virtual local area network identity association of the data based at least in part on whether the communication of the data uses the public network or the private network.

9. The network switch of claim 8, wherein:
the first network device is unaware of the virtual local area network identity association;
the data comprises at least one data packet received from the first network device; and
the second port interface is adapted to insert a tag in the data packet to indicate membership of the packet to a first virtual local area network associated with the private network regardless of whether the communication of the data occurs over the private network or the public network.

10. The network switch of claim 9, wherein:
the communication occurs over the public network; and
the second port interface is adapted to remove the tag from the data packet and communicate the data packet with the removed tag from the network switch to the second network device.

11. The network switch of claim 9, wherein the first network device is unaware of the virtual local area network identity association, the network switch further comprising:
a third port interface adapted to communicate with a third network device adapted to selectively tag data communicated from the third network device to the network switch to regulate a virtual local area network association of the data communicated from the third network device

12. The network switch of claim 11, further comprising:
at least one additional port interface to regulate tagging of data communicated using the at least one additional port to control a virtual local network identity association of the data communicated using the at least one additional port.

13. An apparatus comprising:
a first network device; and
a network switch coupled to the first network device, wherein the network switch is adapted to:
provide a communication path for communication of data between the first network device and a second network device coupled to the network switch; and
regulate tagging of the data to control a virtual local area network identity association of the data based at least in part on a network over which the communication occurs.

14. The apparatus of claim 13, wherein the network switch is adapted to selectively tag the data based at least in part on whether the communication occurs over a public network or a private network.

15. The apparatus of claim 13, wherein the first network device comprises an embedded server management controller unaware of the virtual local area network identity association, the apparatus further comprising:
a server management processor coupled to the network switch to use the network switch to communicate the embedded server management controller over a private network using a first virtual local area network identity associated with the private network.
